(19) United States
(12) Patent Application Publication
(10) Pub. No.: US 2010/0113130 A1
(43) Pub. Date: May 6, 2010

(54) Gaming machine with extensive symbols

(75) Inventors: Kenichi Kamano, Las Vegas, NV (US); Toshiaki Shimizu, Yamato (JP)

Correspondence Address: MASUVALLEY & PARTNERS, 8765 AERO DRIVE, SUITE 312, SAN DIEGO, CA, 92123, US

(73) Assignee: Konami Gaming, Inc., Las Vegas, NV (US)

(21) Appl. No.: 12/291,247

(22) Filed: Nov. 6, 2008

(51) Int. Cl. A63F 9/24; A63F 13/00

(52) U.S. Cl. 463/20

(57) ABSTRACT

The present invention is a gaming machine for providing a display and paying out award, including a storage device which stores a game data to implement at least two games of the same type, an extended device which adds a game element to the two games and a game device which implements the two games of the same type, wherein the extended device works independently of the game device.

### TECHNICAL FIELD

The present invention relates to a gaming machine, which a plurality of people can simultaneously enjoy. Particularly, the present invention relates to a gaming machine provided with an extended device capable of adding a function to the game in addition to a game device for executing a normal game,

### BACKGROUND OF THE INVENTION

So far, various kinds of slot machines have been utilized in casinos. In conventional slot machines, the number of players who can play on one slot machine has been limited to one person. Generally, in many cases, a plurality of people simultaneously visits a casino. In these cases, people had desire to play a game together with the plurality of people rather than to play a slot machine alone. However, the desire was not able to be realized by the conventional slot machines. On the other hand, considering a viewpoint on a casino side, there have been strong needs to raise the sale amount by having as many people as possible simultaneously enjoy a game.

Conventionally, a gaming machine installed in a casino or the like is provided with a game device for executing a normal game, and the game device executes almost all game elements provided in the gaming machine. For example, an arrangement of symbols after rotation of a reel, adjustment of a payout, execution of a secondary game, and the like performed in a slot game are executed by the game device. As described above, the game provided in the gaming machine is conventionally executed by using the game device, and the gaming machine which provides the game by using a different system is desired to be provided on the market in order to provide the game with a lot of variety. Also, harmful effects resulting from the problems that a unit executing the game is only a game device, for example, simplicity of a variety or a volatility of the game, and change of an entire setting of the game device to modify a portion of the game content, are desired to be solved. Gaming machines are required that game results are independent and other game executions or game results cannot affect other game results.

### SUMMARY OF THE INVENTION

One aspect of the present invention may be a gaming machine for providing a display and paying out award, including a storage device which stores a game data to implement at least two games of the same type, a controller which adds a game element to the two games and an executor which implements at least the two games of the same type, wherein the controller works independently of the executor.

By having the above-mentioned structure, two or more players can simultaneously play on one slot machine. By this, people who visit a casino, such as a family, a couple, and friends, can now enjoy a slot game with two or more people. While the machine provides a game with which two or more people can enjoy together, the machine can also provide a game with which two or more players can compete with each other.

At least two games of the same type may have a plurality of symbols with function, and the controller may add other function to any one of the symbols. The executor may implement at least the two games of the same type on the display.

At least the two games of the same type may be a reel game or a card game. By increasing the types of games, which can enjoy two or more players, the game, which is further rich in variety, can be provided.

The controller may add the game element to one game of the two games depending on the other game result of the two games. By having this structure, two or more players playing on one gaming machine can cooperate, or compete each other and play with it. In this configuration, since others' play result influences own play result, more game elements can exist and they can be excited more.

The controller may add the other function to the symbol of one game of the two games depending on the other game result of the two games.

The executor may combine one game result with the other game result in the two games, and may display a combined game result on the display. The executor may combine a game score of one game with a game score of the other game in at least the two games, and may display a combined game score on the display. The executor may combine credit of one game with credit of the other game in the two games, and may display combined credit on the display. The executor may combine an item or a symbol of one game with an item or a symbol of the other game in the two games, and may display combined items or symbols on the display.

By having the above-mentioned structure, it becomes possible to combine a prize, a score, an item, etc. which two or more players playing on one gaming machine obtained and to display it. Therefore, feeling which cooperates between players can bud and a game can be enjoyed also as that of the feeling of cooperation different from playing alone. It is also possible to deduct a prize, a score, an item, etc. which a player gained and to display them. Therefore, the feeling for competing with each other buds and it also becomes possible to perform exciting games.

The gaming machine may include a plurality of displays, and the executor may display at least the two games on the plurality of displays.

Another aspect of the present invention may be a gaming system for providing game play and paying out award, including a storage unit which stores a program for implementing at least two games of the same type and other program for implementing a game independently of the two games, an executor which executes the program after receiving information for operating the executor, a controller which implements the other program independently of the execution of the program after receiving information for operating the controller and a managing unit which transmits the information for operating the executor and transmits the information for operating the controller, wherein the executor works independently of the controller.

By having the above-mentioned structure, two or more players can simultaneously play on one slot machine. By this, people who visit a casino, such as a family, a couple, and friends, can now enjoy a slot game with two or more people. While the machine provides a game with which two or more people can enjoy together, the machine can also provide a game with which two or more players can compete with each other.

The controller may implement the other program for paying out additional award when the award is pay out according to the game play. The total of the award and additional award may be a multiple of the award.

The controller may implement the other game data for providing a coupon or a complimentary. The managing unit may synchronize play cycle between the executor and the controller.

Another aspect of the present invention may be a gaming machine for providing a game play and a payout according to a game result, including a storage device, which stores a game using a symbol with a function, an executor which executes the game and an extended device which adds other function to the symbol, wherein the extended device works independently of the executor.

If the extended device is used, it is possible to add the other function to a symbol, and add the secondary game. In this case, the extended device is independent of the game device, and therefore game property and volatility of the game to be executed by the game device can be significantly changed by a function of the extended device without changing content of the game device. Such extended device can also reduce reapplication time and cost.

The extended device may add the other function that the symbol plays a role as a wild symbol or a jackpot symbol. The extended device may add the other function that a secondary game is begun. The secondary game may be a jackpot game or a roulette game. The executor may execute the game with a trigger condition and the extended device may add another trigger condition to the trigger condition.

By employing the above-described configuration, a property of a game can be significantly changed without changing content of the game device. This causes volatility of the game, and the like to be changed, and therefore can more entertain a player and raise expectations and the like of the player.

The gaming machine further may include a processor, which synchronizes a play cycle in the executor and the extended device. The extended device may implement the other function added to the symbol.

Another aspect of the present invention may be a gaming system for providing game play on a display and paying out award, including a gaming device, including (i) a storage device, which stores a game using symbols with function and (ii) an executor, which executes the game on the display, and a controller which adds other function to the symbols, wherein the controller works independently of the gaming device.

If the extended device is used, it is possible to add the other function to a symbol and add the secondary game. In this case, the extended device is independent of the game device, and therefore game property and volatility of the game to be executed by the game device can be significantly changed by a function of the extended device without changing content of the game device. Such extended device can also reduce reapplication time and cost.

The gaming system further may include a managing system, the gaming device may transmit play activity information to the managing system, and the managing system may transmit operating information related to the other function to the controller.

By employing the above-described configuration, a casino manager or the like can arbitrarily change content of a game to be executed in the gaming machine. That is, the casino manager or the like can issue an instruction to the controller so as to add any function to the game content through the gaming system, and therefore the casino manager can control the game. By doing so, the casino manager can control the game content in consideration of a player's psyche with viewing a play situation, and therefore needs of the player can be further satisfied.

The controller may add the other function for paying out additional award when the award is paid out according to the game play. The total of the award and additional award may be in multiples of the award. The controller may add the other function for providing a coupon or a complimentary. The controller may implement the other function added to the symbols.

By employing the above-described configuration, a property of a game can be significantly changed without changing content of the game device. This causes volatility of the game to be changed, and therefore can more entertain a player and raise expectations and the like of the player.

Another aspect of the present invention may be a method for playing a game, including the steps of receiving wager, presenting a first game with a set of symbols by a first means, adding element to the first game by a second means, playing a second game which has the element added to the first game, analyzing outcome of the second game, determining whether the outcome is winning outcome and awarding a reward when the outcome is winning outcome, wherein the first means works independently of the second means.

When the extended device is used, it is possible to add the other function to a symbol and add the secondary game. In this case, the extended device is independent of the game device, and therefore game property and volatility of the game to be executed by the game device can be significantly changed by a function of the extended device without changing content of the game device. Such extended device can also reduce reapplication time and cost.

The method may include the step of presenting a symbol with a function by the first means and the step of adding the other function to the symbol by the second means. The element may be a bonus. The bonus game may be a jackpot game or a roulette game. The method may include the step of presenting a set of symbols with a trigger condition by the first means and the step of adding another trigger condition to the trigger condition by the second means.

The adding step may be the step of adding the element for paying out additional award when the award is pay out according to the game play. The method further may include the step of implementing the element by the second means.

By employing the above-described configuration, a property of a game can be significantly changed without changing content of the game device. This allows volatility of the game to be changed, and therefore can more entertain a player and raise expectations and the like of the player.

Another aspect of the present invention may be a gaming machine, which is capable of receiving a bet and paying out a reward, including a game device, which is capable of executing at least two games, a controller, which operates one game of the two games and another controller, which operates the other game of the two games,

The gaming machine may be linked to at least the other gaming machine. The gaming machine may include an extended device, wherein the game device may execute a game operated by the controller, the extended device may execute a game operated by the another controller and the game device may work independently of the extended device.

A type of the one game may be different from a type of the other game. A type of the one game may be the same as a type of the other game. The game device may be capable of executing at least two games at substantially the same timing. The game device may synchronize with the extended device on play cycle. The gaming machine may further include an extended device, wherein the extended device may apply an additional element to the one game.

### BRIEF DESCRIPTION OF THE DRAWINGS

FIG. 1 is a perspective view illustrating an example of a gaming machine of the present invention.

FIG. 2 is a diagram illustrating a configuration of the gaming machine according to the present invention.

FIG. 3 is a diagram illustrating a configuration of a managing system according to the present invention.

FIG. 4 is a diagram illustrating a relationship between a game device and an extended device.

FIG. 5 is a diagram illustrating a case where a plurality of game devices is present.

FIGS. 6 and 7 are diagrams illustrating an example of a function executable by the extended device according to the present invention.

FIG. 8 is a diagram illustrating an example of a function executable by the extended device according to the present invention.

FIGS. 9 to 11 are diagrams illustrating an example of a function executable by the extended device according to the present invention.

FIG. 12 is a diagram illustrating an example of award combinations created by the game device and extended device.

FIG. 13 is a diagram illustrating an example of two games executable by the gaming machine according to the present invention.

FIG. 14 is a diagram illustrating an example of a configuration of the gaming machine according to the present invention.

FIG. 15 is a diagram illustrating an example of a configuration of the gaming machine according to the present invention.

FIG. 16 is a diagram illustrating an example of the present invention.

FIG. 17 is a diagram illustrating an example of two games executable by the gaming machine according to the present invention.

FIG. 18 is an example of a flowchart of operations executed by the gaming machine according to the present invention.

FIG. 19 is an example of a flowchart of operations performed by the gaming machine according to the present invention.

### DETAILED DESCRIPTION OF THE INVENTION

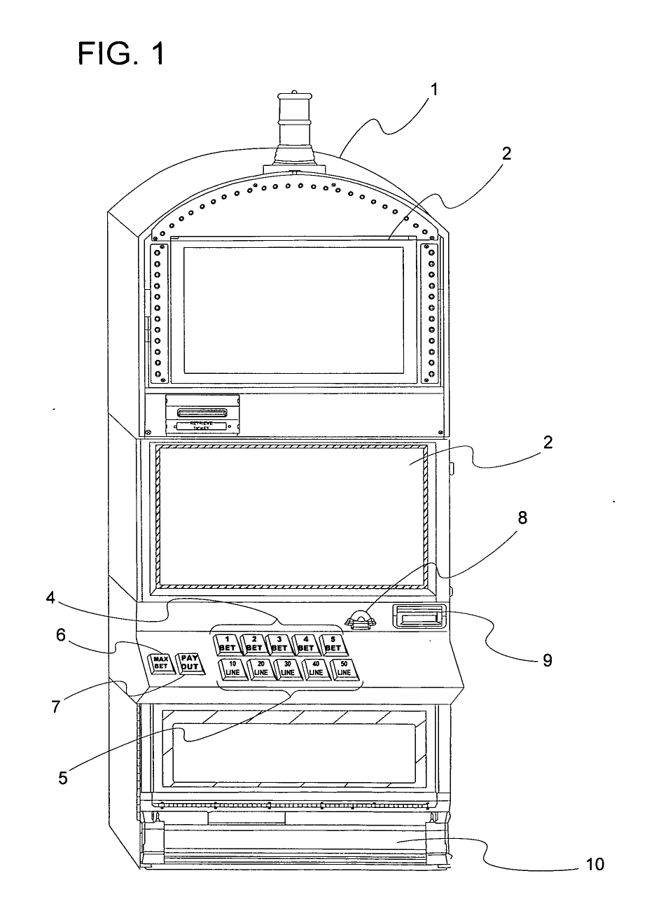

FIG. 1 is a perspective view illustrating an example of a gaming machine of the present invention. As illustrated in FIG. 1, a gaming machine 1 is provided with two displays 2. Immediately below the displays 2, a BET switch 4, select switch 5, MAX BET switch 6, PAYOUT switch 7, coin slot 8, and inlet/outlet for banknote or the like 9 are provided. The BET switch 4 has five switches respectively for “1BET” to “5BET”. The select switch 5 has five switches respectively for “1select” to “5select”. Also, in a lower part of the gaming machine 1, a coin payout port 10 is provided.

On the displays 2, a display necessary for a player to play a game is provided. For example, on the displays 2, a display for playing a primary game or secondary game is provided. On the displays 2, for example, playing cards used in a card game, a wheel and coins used in a roulette game, reels and features used in a reel game, or the like are displayed. Also, a display for the player to select the type of a progressive game or bonus game, or one for the player to select the feature is provided. Alternatively, on the displays 2, a progressive game screen, or the like, on which an amount of money the player may win may be displayed. Still alternatively, on the displays 2, presentation according to progress of a game, a credit being inputted into the gaming machine by the player, a play history of the player, or the like may be displayed.

The BET switch 4 is a switch for putting a bet in a game. The player can use the BET switch 4 to put any of the bets from “1BET” to “5BET” for a single play of the game. The select switch 5 is a switch for selecting, for example, a card the player would like to discard, a line on reels, or the like. The numbers of switches included in the BET switch 4 and select switch 5 are not limited to five, respectively, but may be any numbers. Alternatively, the gaming machine 1 may have, for example, a switch for betting “10BET”, or a switch for “10select”.

The MAXBET switch 6 is a switch for putting in the maximum bet that the player can bet on a single play of a game. The PAYOUT switch 7 is a switch for paying out an amount of money credited to the gaming machine back to the player. The coin slot 8 is a hole for the player to credit coins to the gaming machine. The inlet/outlet for banknote or the like 9 is a hole used for inserting a banknote or cash card into the gaming machine, or paying out an amount of credited money. The coin payout port 10 is intended for paying out the amount of money credited to the gaming machine back to the player.

The gaming machine according to the present invention is not limited to the above, but may be provided with various functions in addition to the above functions, or omit some of the above functions. For example, the gaming machine may have a lighting device for lighting the gaming machine with one or more different colors when the player enters the secondary game. Alternatively, the gaming machine may have a device for vibrating the entire game machine or outputting music when the player enters the secondary game. Still alternatively, the gaming machine 1 may have three or more displays. Yet alternatively, the gaming machine 1 may have a switch for again selecting “BET” the player bet on a previous play of the game.

Also, a reel, wheel, or the like used in a game may not necessarily be displayed on the displays, but the gaming machine 1 may be loaded with a stepper (mechanical reel), mechanical wheel, or the like. Further, a display used for a plurality of gaming machines in common may exist.

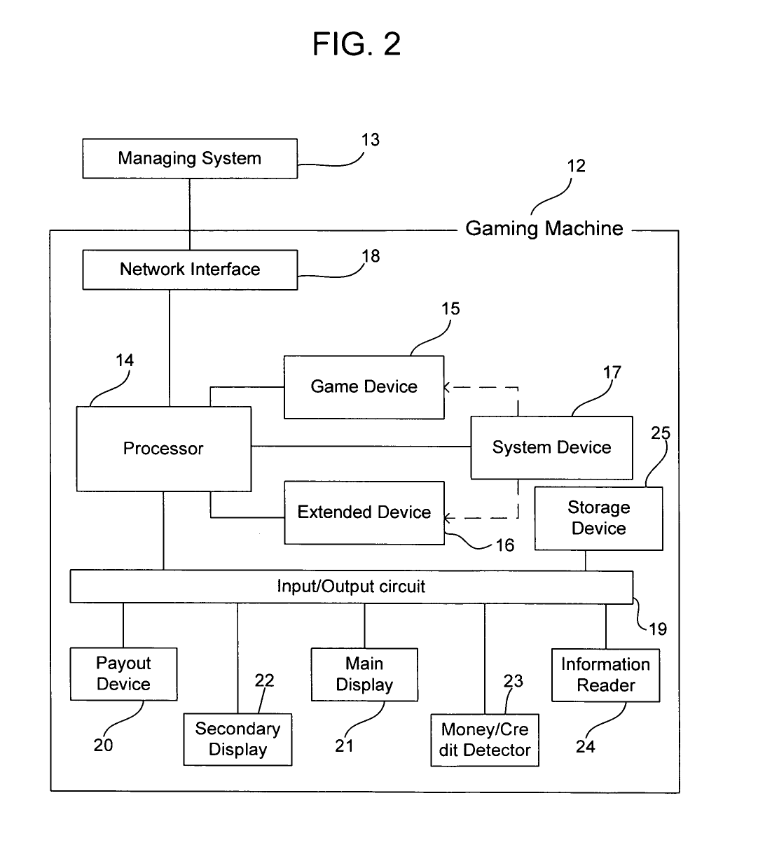

FIG. 2 is a diagram illustrating a configuration of the gaming machine according to the present invention. In FIG. 2, a gaming machine 12 and managing system 13 are illustrated. The gaming machine 12 is a machine for providing a game to a player, and installed on a casino floor, or the like. On the other hand, the managing system 13 is a system provided such that the manager on the casino side can operate the gaming machine 12. Through the managing system 13, the manager can change a setting of the gaming machine 12, or refer to information accumulated in the gaming machine 12.

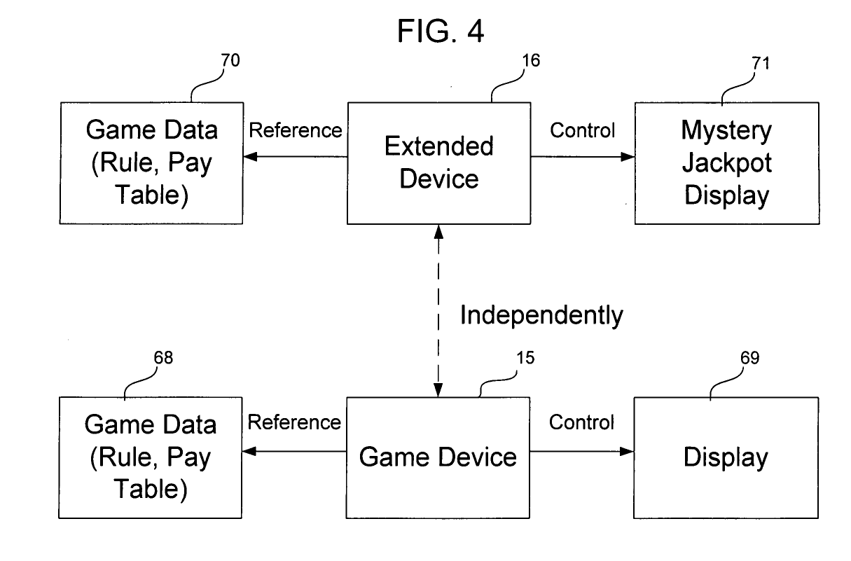

The gaming machine 12 is installed with a processor 14, which controls various devices and the like. As the various devices, a game device 15, extended device 16, system device 17, network interface 18, and input/output circuit 19 are provided. The processor 14 is adapted to be able to make contact with the managing system 13 through the network interface 18. The game device 15 is a part that controls a basic portion of the game to be provided to the player. The extended device 16 is a device that operates completely independently of the game device 15, and may provide a game completely independent of the game to be provided by the game device 15 or provide a game having content related to the game to be provided by the game device 15. The game device 15 and extended device 16 will be described in detail with reference to FIG. 4 and subsequent drawings.

On the other hand, the input/output circuit 19 is connected with a payout device 20, main display 21, secondary display 22, money/credit detector 23, information reader 24 and storage device 25. The payout device 20 is a device for paying out a credit or award depending on a game result. The main display 21 is a display for displaying a game to be provided by the game device 15 or the like. The secondary display 22 is a display for displaying a game to be provided by the extended device 16 or the like. The money/credit detector 23 is a detector for detecting cash or a credit card inserted into the machine by the player. The information reader 24 is a reader for reading information on the player from the inserted player's card or the like. The storage device 25 is a memory for storing various programs and game data such as game rules, pay tables and the like. The processor 14 is set through the input/output circuit 19 so as to be able to operate such devices.

Meanwhile, the system device 17 plays a role of making synchronization of a play cycle among the above-described various devices. For example, the system device 17 transmits an instruction to start a game on the display upon receipt of an instruction from the player indicating that a bet has been placed, or transmits an instruction to display a game result upon receipt of an instruction indicating that a predetermined game has been completed. Also, the system device 17 transmits an instruction for payout according to a display of the game result. Alternatively, the system device 17 may realize a function of matching the play cycles of the game device 15 and extended device 16.

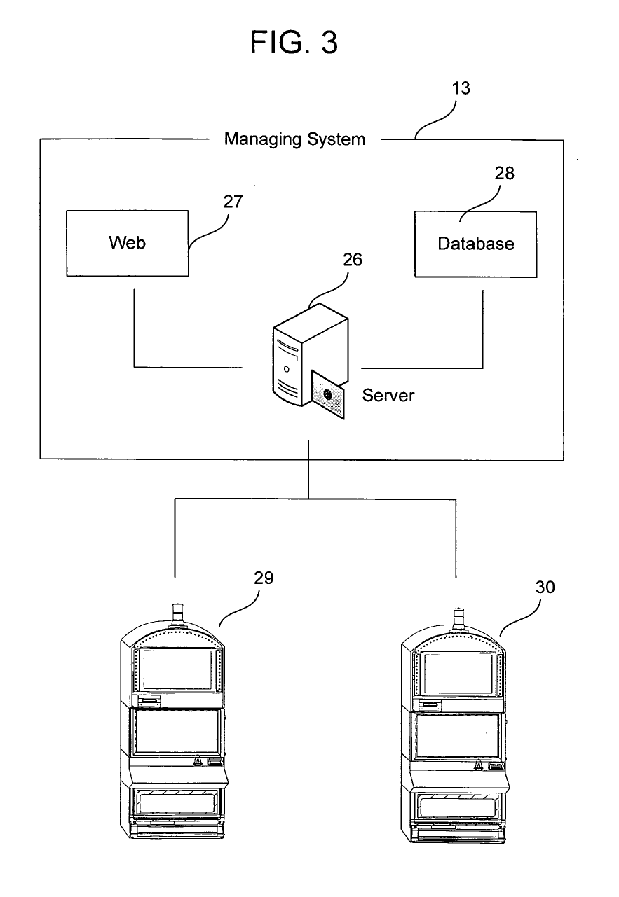

FIG. 3 is a diagram illustrating a configuration of the managing system according to the present invention. In FIG. 3, the managing system 13, and gaming machines 29 and 30 are illustrated. Components of the managing system 13 may include, for example, a server 26, web 27, database 28, and the like. The casino manager can access the server 26 to acquire information from the web 27 or database 28, or store information in the database 28. Also, the casino manager can use the managing system 13 to control a plurality of the gaming machines, and store/acquire pieces of information into/from the gaming machines. Said pieces of information include, for example, game content, game rule, pay table, value of cash or credit, individual information on a player, play activity information, and the like.

Note that, in FIGS. 2 and 3, the components of the gaming machine and managing system according to the present invention are described; however, the components are not limited to them, but unshown components may be provided. For example, the numbers of the game devices 15 and extended devices 16 may not necessarily be one, respectively, but pluralities of the gaming devices 15 and extended devices 16 may be provided. Also, even if any of the components illustrated in FIGS. 2 and 3 is missing, the gaming machine and managing system of the present invention can play their roles. For example, it goes without saying that even if the secondary display 22, information reader 24, and the like are missing from said gaming machine, features of the present invention can be realized.

FIG. 4 is a diagram illustrating a relationship between the game device and the extended device. In FIG. 4, the game device 15 and extended device 16 are illustrated. These devices are characterized by operating independently of each other. Also, these devices can provide games to players by executing or implementing independent programs respectively, and refer to pieces of game data (game rules, pay tables, and the like) 68 and 70, independently of each other. For example, the game device 15 can use a display 69 to provide various games to the player, whereas, independently of this, the extended device 16 may use a display 71 to provide a game completely different from that provided by the game device 15. In this case, the extended device 16 may provide the same type of game as that provided by the game device 15. Also, with the game device 15 providing a certain game to the player, the extended device 16 may play a role of adding some sort of function to the game provided by the game device 15. Accordingly, in this specification, the game device 15 is used as an executor and the extended device 16 is used as a controller respectively. Note that the games respectively provided by the game device 15 and extended device 16 may not necessarily be played on separate displays, but may be played on the same display.

Specifically, we assume that, for example, the game device 15 provides a slot game displaying symbols; as a result of a player's play of the game, the symbols are arrayed on a display; and a credit is determined to be paid out. In this case, because the symbols are arrayed on the display, the extended device 16 may, in addition to paying out the predetermined credit, further pay out a credit with reference to the game result. Alternatively, the extended device 16 may, in addition to paying out the predetermined credit, additionally issue a coupon, complimentary ticket, gift certificate or the like. On the other hand, for example, the game device 15 may provide a normal game (slot game, card game, keno game or the like), and depending on a result of the game (e.g., in the case where symbols are arrayed, or in other case), the extended device 16 may provide another game (secondary game, or the like) to the player.

The extended device 16 may add a function to a symbol or provide another game at any time. For example, the extended device 16 can refer to game content, game result, game rule, and the like controlled by the game device 15, and therefore may operates at a time when the game device 15 executes a predetermined operation. The time when the game device 15 executes the predetermined operation may be any time, such as a time when a winning combination is displayed, the number of rotations of a reel reaches a predetermined number of times, a certain period of time elapses, a player performs a certain operation, a BET amount reaches a predetermined amount, a payout exceeds a certain amount or a predetermined number of players play.

On the other hand, the extended device 16 may add a function to a symbol at its own time without referring to the game result or the like of the game device 15. The own time for this case includes, for example, a time when a certain period of time elapses, a BET amount reaches a predetermined amount, a payout exceeds a certain amount, or the like. Alternatively, the extended device 16 may, without referring to the game result or the like of the game device 15, add a function to a symbol at a time when receiving an instruction from a component other than the game device 15.

If the extended device 16 refers to the game result or the like of the game device 15, it may refer to past game content, game result, game rule, or the like, or only to a present play situation. For example, if the extended device 16 refers to the past game result, it may refer to a game history before a reel rotates a predetermined number of times (e.g., 50 rotations, 100 rotations or the like), or a game history several hours before. Alternatively, the extended device 16 may comprehensively refer to a history of a game that had been played during a predetermined period of time (from three hours before to two hours before or the like) or a history of a game that had been played within a predetermined range of rotations of a reel (from previous 200 rotations to previous 100 rotations or the like).

Also, the extended device 16 may be set to add a function to a symbol for an event to potentially occur in the future. For example, the extended device 16 may add a function to a symbol after the game device 15 has rotated a reel a predetermined number of times. For example, the extended device 16 may be set to add a function to a symbol when the game device 15 displays a predetermined single symbol.

On the other hand, said managing system 13 can operate the extended device 16, and, for example, according to an instruction from the management system 13, the extended device 16 may add a function to a symbol. Because a configuration is made as described, the casino manager may perform payout from the gaming machine at his/her own time. Generally, if play activity information is transmitted from the gaming machine to the managing system 13, the managing system 13 transmits to the extended device 16 an instruction to add a function to a symbol.

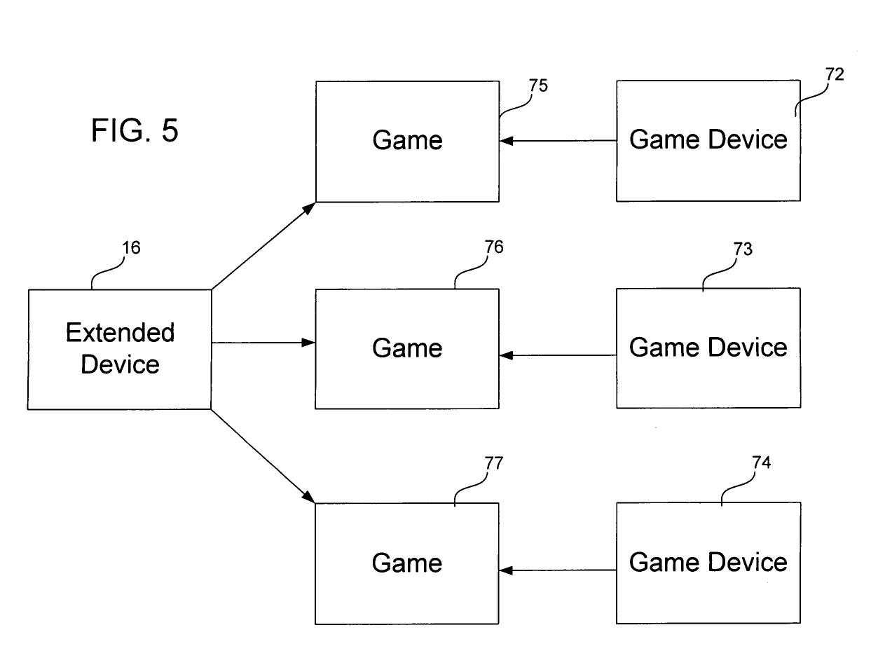

FIG. 5 is a diagram illustrating a case where a plurality of game devices is present. In FIG. 5, three game devices 72, 73 and 74 and the extended device 16 are illustrated. The three game devices 72, 73, and 74 respectively control games 75, 76, and 77. As illustrated, the extended device 16 adds functions to the three games 75, 76, and 77. As described, the one extended device is present not only for one game device, but the extended device adding the functions to the plurality of game devices may be present. On the other hand, a plurality of extended devices adding functions to one game device may be present. In the former case, times when the extended device adds the functions may be the same or different for each of the plurality of game devices. In addition, the plurality of game devices 72, 73, and 74 may be respectively loaded in one gaming machine, or in a plurality of gaming machines to provide the games in the respective gaming machines.

Generally, to change content of a game to be executed by the game device, a setting of the game content should be changed for each of the game devices. Also, when content of another game such as a secondary game is changed, it is necessary to change the content and then reapply the changed content. Such setting change of the game content and reapplication typically require significant time. As described above, if the extended device is used, it is possible to add a function to a symbol, and add the secondary game. In this case, the extended device is independent of the game device, and therefore game property and volatility of the game to be executed by the game device can be significantly changed by a function of the extended device without changing content of the game device.

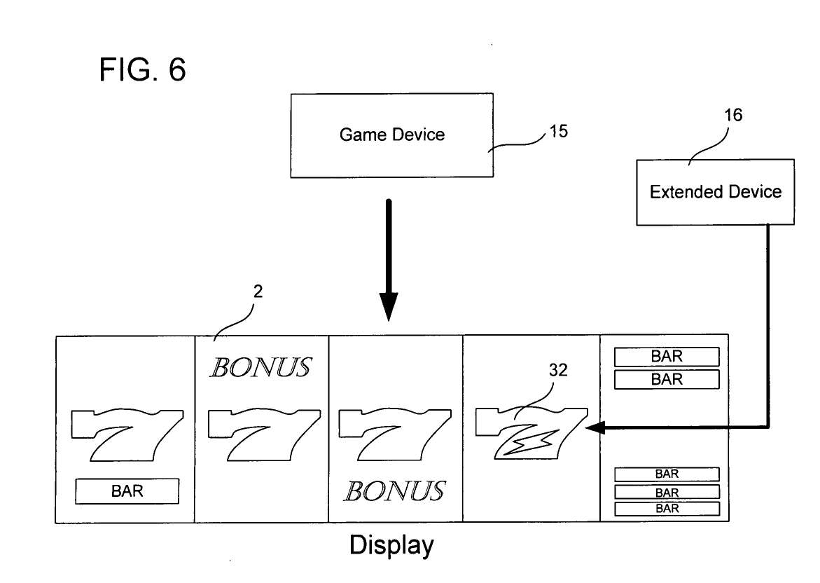

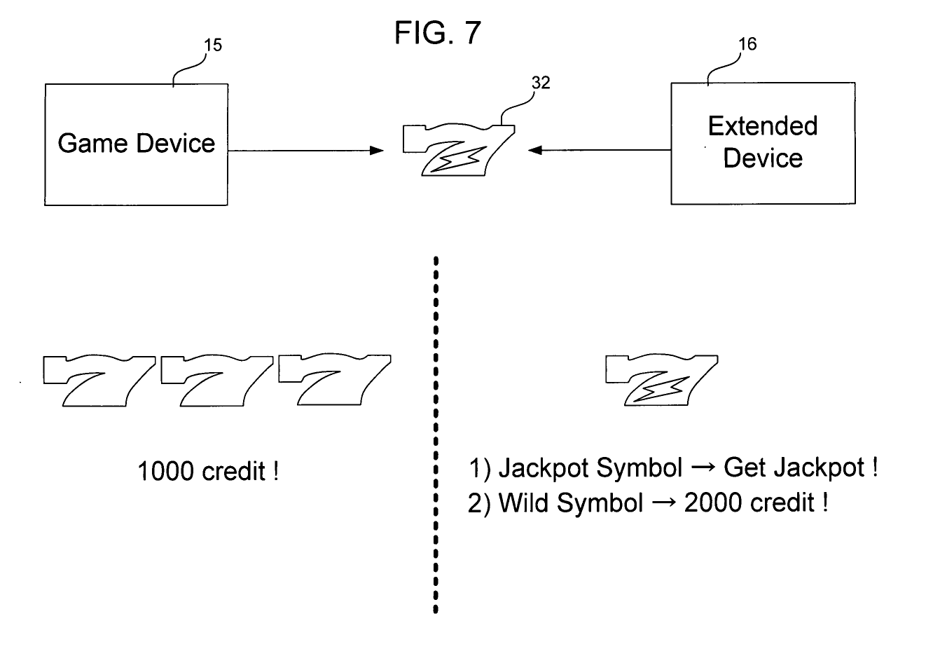

Hereinafter, specific examples of a function, game, and the like the extended device can add are described. FIGS. 6 and 7 are diagrams illustrating an example of a function executable by the extended device according to the present invention. In FIG. 6, the game device 15 is illustrated, and a reel game executed by the game device is displayed on the display 2. Also, in FIG. 6, the extended device 16 is illustrated, and the extended device plays a role of adding a function to a symbol appearing in the reel game executed on the display 2.

An example is taken to give a description. For example, in the center of the display 2, three symbols “7” are arrayed, and beside the symbols, a symbol 32 is aligned. If the extended device 16 does not add any function to a symbol, the symbol 32 is not involved in payout or bonus at all, and as illustrated in FIG. 7, a 1000 credit is paid out to a player. On the other hand, for example, if the extended device 16 adds a function of playing a role as a jackpot symbol to the symbol 32, the symbol 32 appearing on the display 2 will enable the player to get a jackpot award. Alternatively, for example, if the extended device 16 adds a function of playing a role as a wild symbol to the symbol 32, the symbol 32 is considered to play the same role as the symbol “7”, so that the four symbols “7” are considered to be arrayed in the center of the display 2, and therefore an amount (e.g., 2000 credit) larger than that for the case where the three symbols “7” are arrayed will be paid out.

If the extended device 16 adds a function, it may realize the additional function at its own discretion because it originally has information to be added to a symbol. On the other hand, because a symbol operated by the game device 15 originally has a plurality of attributes (e.g. in the case of attributes respectively enabling some symbol to become a jackpot symbol and a wild symbol, etc.), the extended device 16 may refer to such attributes to select one or more of the attributes, and add the attributes to the symbol such that the symbol can realize the attributes.

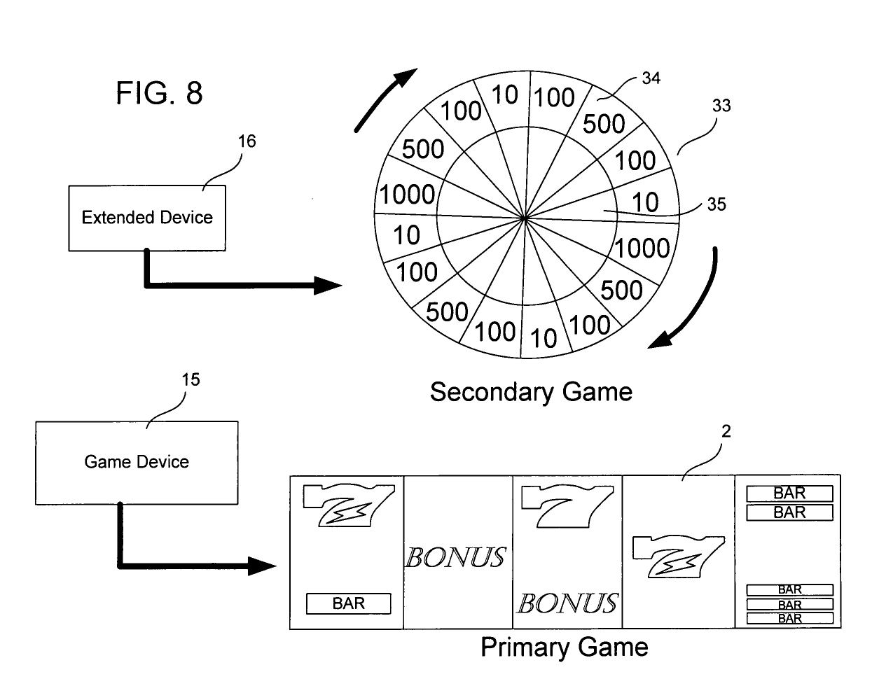

FIG. 8 is a diagram illustrating an example of a function executable by the extended device according to the present invention. In FIG. 8, a primary game (reel game) executed by the game device 15 is displayed on the display 2. The extended device 16 refers to the symbol of the primary game to execute a secondary game. Here, the secondary game is a wheel game, and a wheel 33 is used to proceed with the secondary game. The wheel 33 has, for example, an outer frame 34 and inner frame 35, and on the outer frame, payouts are displayed. The secondary game executable by the extended device is not particularly limited, but a bonus game using a reel, bonus game making a player select any of a plurality of objects, or the like is executable.

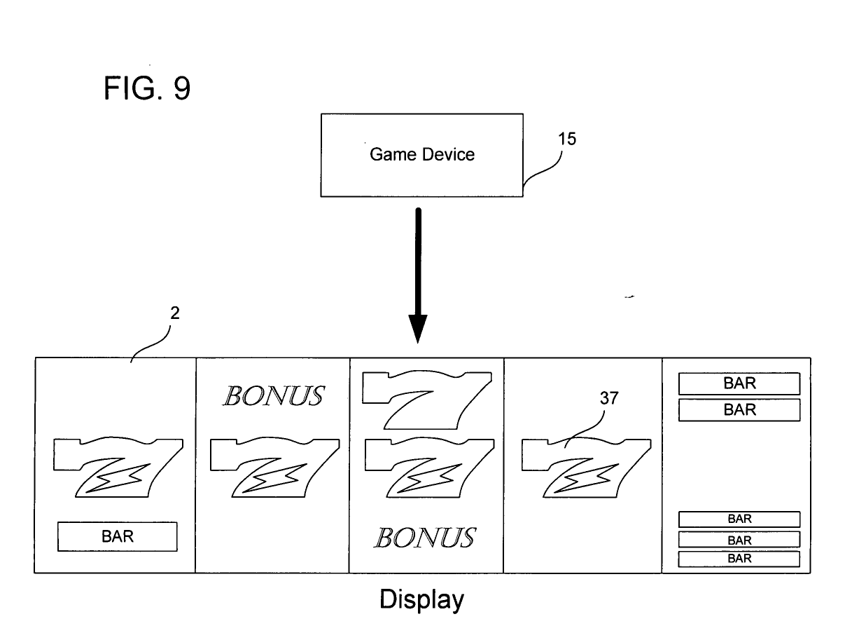

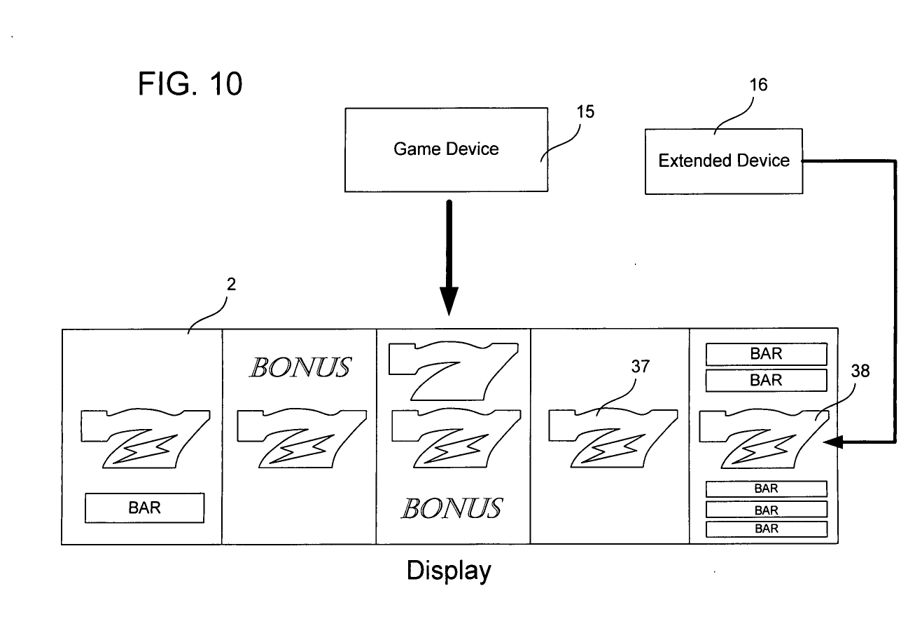

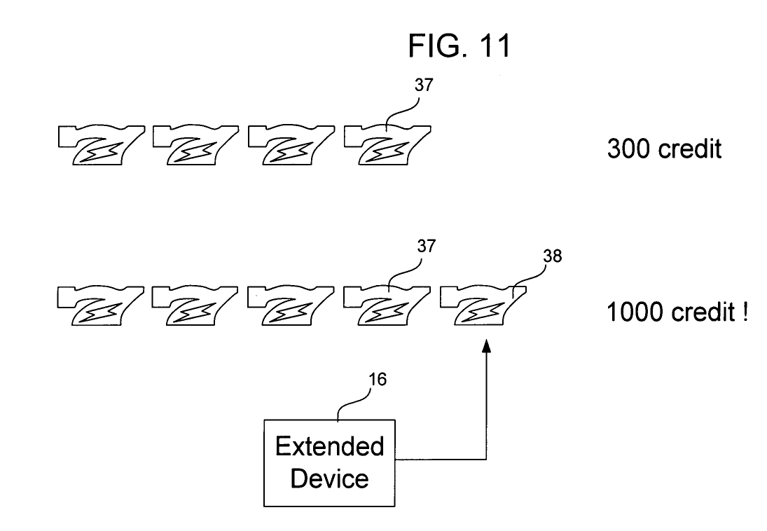

FIGS. 9 to 11 are diagrams illustrating an example of a function executable by the extended device according to the present invention. In FIG. 9, the game device 15 executing a reel game on the display 2 is illustrated. In the center of the display, four symbols 37 are arrayed. In this case, the extended device does not particularly add a function, and as illustrated in FIG. 11, a 300 credit is paid out. FIG. 10 illustrates a state where the extended device 16 has added a symbol onto the reel display. As can be seen from FIG. 10, in the center of the rightmost reel on the display, the symbol 38 is added by the extended device. When this state is reached, the four symbols 37 as a game result by the game device and the symbol 38 added by the extended device are taken into account to pay out a 1000 credit as illustrated in FIG. 11. As described, the extended device not only adds a function to a symbol present in a game executed by the game device, but may also display a new symbol on a display.

On the other hand, the extended device may delete a symbol present in a game executed by the game device. For example, even if a program is set to array four symbols on a display during execution of a reel game by the game device, the extended device may delete one of the four symbols to actually display the three symbols on the display by implementing the other program.

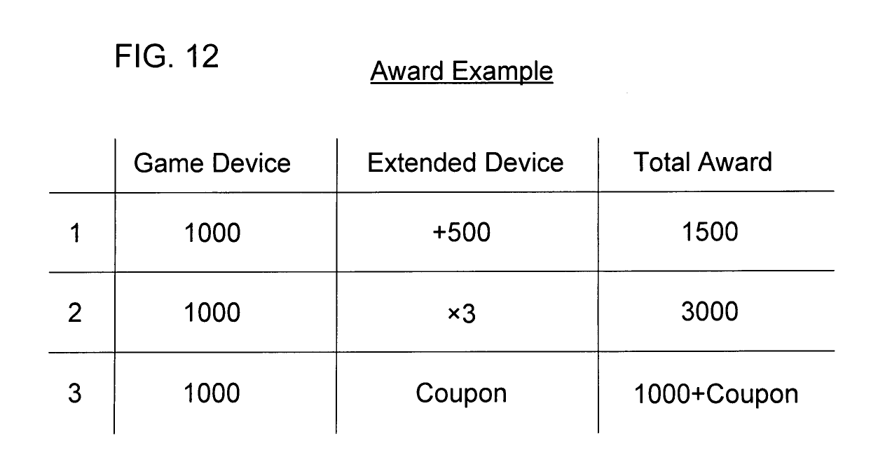

FIG. 12 is a diagram illustrating an example of award combinations created by the game device and extended device. FIG. 12 illustrates three patterns, i.e., No. 1 to No. 3 patterns, and the game device constantly pays out a 1000 credit. In the No. 1 pattern, the extended device pays out a 500 credit independently of the game device, and therefore a total award to be paid out to a player is a 1500 credit. On the other hand, in the No. 2 pattern, the extended device adds a function of multiplying by 3 a payout determined by the game device, and therefore the total award is a 3000 credit, i.e., 1000 (“1000” due to the game device) multiplied by 3 (“×3” due to the extended device). As described, the extended device also has a function of multiplying by some number a payout determined by the game device.

Further, in the No. 3 pattern, the extended device issues a coupon ticket independently of the game device, and therefore an award finally obtainable by a player is a 1000 credit plus the coupon ticket. The additional payout by the extended device is not the coupon ticket, but may be a complementary ticket, gift certificate, cash, point, ticket (meal voucher, etc.) or the like.

As above, the functions and games the extended device can add have been described, however, the extended device is not limited to the above. For example, the number of functions the extended device can add to one symbol may not necessarily be one, but any number of functions, such as a jackpot symbol function and wild symbol function, may be added at once. Also, the number of symbols to which the extended device can add functions is not one, but predetermined functions may be added to two or more symbols. In this case, the functions to be added to the two or more symbols may be the same, or different. Further, the extended device may add a condition to a trigger condition defined by the game device to finally change the entire trigger condition.

Also, a game executed by the game device is not only a reel game, but various games such as a card game and keno game are executable. The extended device can add a function to a symbol present in any of the various games, and further add a game element (such as a secondary game). For example, in a poker game, a four-card hand may be made as a result of the same three cards shown by the game device and the same one further shown by the extended device, or other hand may be made.

Note that, in the present invention, the addition of a function or game element by the extended device is described; however, a unit to execute the additional function or game element may be essentially the extended unit. It should be appreciated that the unit to execute the additional function or game element may be any device other than the extended device.

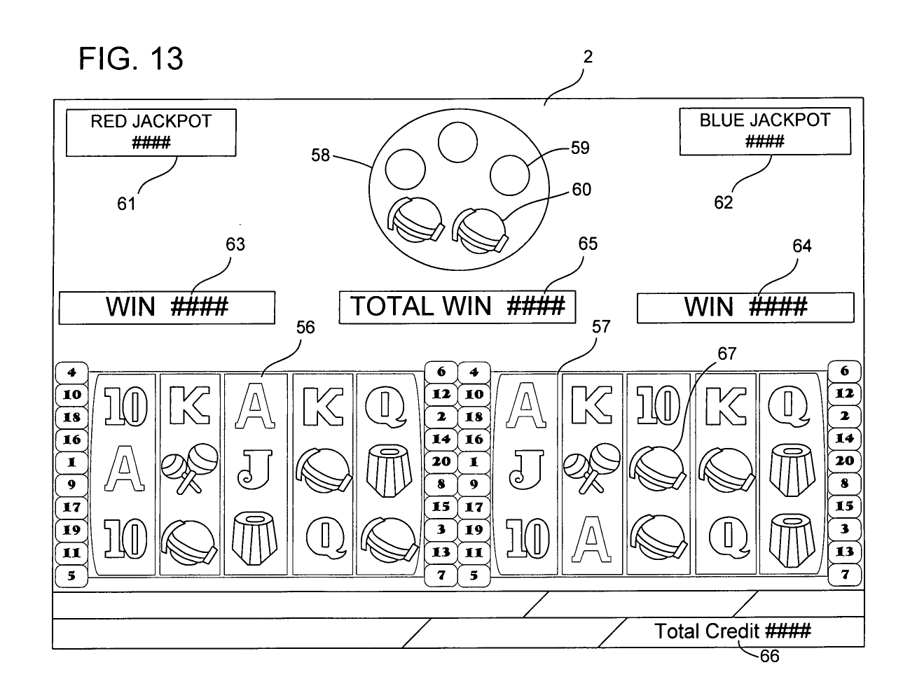

Next, another game embodiment of a gaming machine related to the present invention will be described. FIG. 13 is a diagram illustrating an example of two games, which is executable by the gaming machine according to the present invention. FIG. 13 illustrates display 2. Two reels 56 and 57 are shown in display 2. A player can use and play on one of these two reels, and other player further can use and play another reel. By using these two reels, they are able to compete, or two players to cooperate to play the game. The number of reels displayed on display 2 may not be limited in particular, but may be any number. The number of players, which can play a slot game according to it, may be any number.

Reels 56 and 57 can perform different motions independently, or can perform the same motion. For example, the different motion is to rotate symbols in different timings or to display different symbols. Usually, the symbol displayed on the reel is selected from symbols determined in advance. However, in cases where different symbols are displayed on both reels, types of the symbols determined in advance may differ. For example, a wild symbol of a dragon is displayed and a wild symbol of a diamond is not displayed on reel 56. On the other hand, the wild symbol of a diamond may be displayed and the wild symbol of a dragon does not need to be displayed on reel 57. On the other hand, a symbol, which may be displayed on both reels may be the same. That is, although timing at which the same type of symbols (dragon etc.) are displayed on the reels differs, a symbol selected from the same symbols (a dragon, a jar, a lamp, etc.) may always be displayed on both reels.

On the other hand, completely the same symbol may be displayed on both reels at the same timing. For example, when it rushes into a free spin game, the same pattern may be arranged on the pay line on both reels for every spin and the same award amount may be paid back. And the spin, which displays the same pattern on both reels, may be executed continuously, and it may continue to the end of the free spin game. It may continue only a predetermined number of times. As described above, when gaming machine is set up, a symbol shown on a reel in the primary game and its timing differs from those of each reel, but unification feeling can be given to both reels in the free spin game. As a result, in the primary game, a player works in order to draw a free spin game separately, respectively. Since both reels become the same in a case when one of players draws a free spin game, feeling with which both players have cooperated can be provided more.

The type of symbols displayed on the reel may change at a certain timing. For example, when rushed into a bonus game, the type of symbols displayed on both reels change, and, as a result, a dragon is usually displayed, for example, in a primary game, but a dragon which vomits a flame in a bonus game may come to be displayed. On the reel, a game having a big award may be performed and a game, which does not have a big award may be performed on a certain reel on a certain timing. When configuring the gaming machine in this way, in cases where two players will compete each other on a game, a big difference can be given to the game results of both players, and it is possible to strongly give impact on victory and defeat to both players. With respect to the contents of a game of the big award, there may be a case where symbol combinations, in which award is made, is continuously arranged and a case where symbol combinations, in which award is made, is not arranged, for example. With regard to the contents, for example, there may be a case where the symbol combination in which a big award is made is arranged on a pay line or a case where the symbol combination in which a big award is made is not arranged on a pay line.

The patterns on both reels may interchange at a chance of certain timing. For example, in cases where a symbol combination having a big award is arranged on reel 56, a combination of the big award may shift to reel 57 from reel 56 with a chance at certain timing. And an award may not be made on reel 56 to which this combination was arranged first. Instead, an award may be made on reel 57. The awards of reels 56 and 57 are usually performed against players, which are playing the reels, respectively. However, all the awards against the symbols, which are arranged within a certain fixed time on reels 56 and 57 may be made only against one player. By taking in these rules into a game, competitive spirit of players can be fueled more and the play can be active.

The number of cells of two reels may be the same or may differ each other. Although a reel having a matrix of 3×5 is displayed in FIG. 13, the number of cells of one reel may change to a matrix of 4×5 or 5×5 at a chance at certain timing, for example. The number of pay lines on two reels may be the same or may differ. For example, pay lines of two reels may be set up so that the pay lines differ in a primary game and the pay line may be set up so that one player can enjoy the game with many pay lines and the other player can enjoy the game with few pay lines. The number of pay lines may increase or become fewer suddenly with a chance at certain timing. When the number of these cells and the number of pay lines are configured to increase when a certain symbol combination is arranged, for example, a style or volatility of a game can be changed. Therefore, a game becomes more effective.

The results of not less than two reel games may affect mutual plays. For example, in cases where a symbol, which can increase or decrease the amount of a credit of other player appears on reel 56, the amount of the credit of player of reel 57 may be increased or decreased. The number of times of the remaining spin of others' free spin game is increased or reduced at a chance of certain incident, for example. Appearance probability of a predetermined symbol displayed, for example, on others' reel may be increased or decreased with a chance of a certain incident. A symbol displayed, for example on others' reel may be changed at a chance of certain incident. (For example, the color of a diamond symbol may change or a mere pot symbol may change to a pot in which a magician has appeared).

In cases where the result of a certain reel game affects the game of other reels, the player may be allowed to select which reel game is affected. For example, in cases where a game is played by three people (A, B, C), when a player which can give affection is set to A, player A can be selected so that player B may be affected. It can also select so that both players B and C may be affected. The other reels to be affected may be automatically selected by the gaming machine.

A game of a tournament method, a game of a team event, etc. may be performed using a plurality of reels. For example, in cases where reels A, B, C and D exist, a game of the tournament method may be performed in a form where reels A and B, and reels C and D may play the first game against each other, respectively. Reels A and B and reels C and D may constitute a team, respectively, and a game of a team event may be performed.

A function which extended device above-described has (a function to add a certain function to the symbol with reference to a symbol, a function to add a new game to a game which game device executes, a function to issue an award, a free ticket, etc. additionally according to the award of the game which game device executes, etc.) is also applicable to the game configuration which uses these two reels. For example, it is also possible to add a certain function to symbol of reel 57 with reference to the symbol of reel 56. When there is award on reel 56, the extended device is able to pay back simultaneously on reel 57 other than the reel.

FIG. 13 will be described in more detail. FIG. 13 illustrates an example of the game by which two players play the game with cooperation. The credit, which each player gained in the game, is shown in WIN displays 63 and 64, respectively. Sum total, which two players gained in a game, is displayed on TOTAL WIN display 65 so that the credit two players might have gained together is recognized at a glance. The sum total of the credit which two players own within a game machine now is shown in TOTAL Credit display 66. RED61 and BLUE62 exist in a type of JACKPOT. The game may be designed so that several percent of the credit, which a player has betted may be accumulated into the JACKPOT. In this case, a betted amount on reels 56 and 57 may be accumulated. Only the betted amount on one of reels may be accumulated. The game may be set so that RED JACKPOT61 wins only on reel 56 and BLUE JACKPOT62 wins only on reel 57. Displays of 61-66 may be used when necessary.

Shared symbol 58 is shown in display 2. Shared symbol 58 has a role, which stocks symbols displayed on reel 56 or 57 according to predetermined conditions, and it is possible to stock a symbol in holder 59. The symbols, which appeared as winning combination on the pay line on reels 56 and 57 are stocked in shared symbol 58. For example, symbol 60 is stocked. And when all the holders 59 are filled with symbols, a bonus game may start. Any kind of conditions for stocking a symbol on holder 59 may be acceptable, and the case where a predetermined symbol is only shown on a reel may be acceptable. The case where symbols more than a predetermined number are shown on the reel may be acceptable. The type of symbol to be stocked may be one kind of symbol determined in advance, and may be two or more kinds of symbols.

For example, it may be designed so as to limit the symbol stocked within the limits having a unity. For example, there are five colored diamonds and a certain event is started as a result that all the five colored diamonds have been stocked. The number of symbols, which can stock shared symbol 58, does not need to be five, and any number may be acceptable. The event started as a result of the symbol of the predetermined number being stocked in the shared symbol 58 may be anything. These events may be a free spin game, a treasure box selection game, a bonus game, JACKPOT acquisition, etc. These events may be issue of meal tickets, the award of money, etc instead of the game start.

The plurality of games executed on display 2 may not be reel games. For example, the plurality of games may be card games, such as blackjack and poker, and may be a keno game.

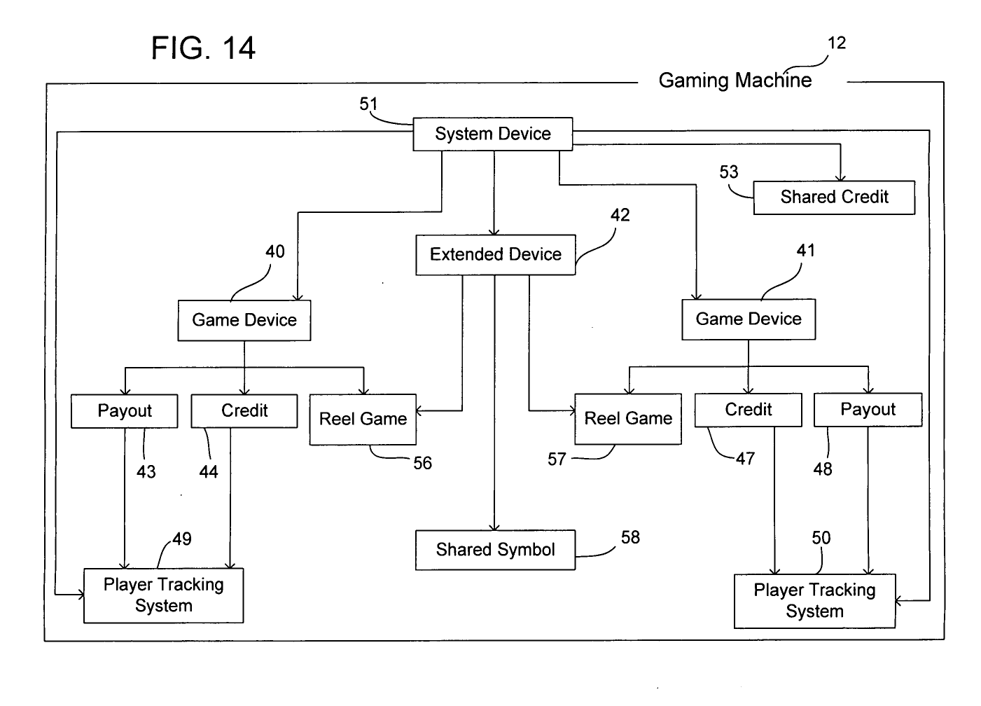

Next, an internal system, in case a gaming machine related to the present invention executes two or more games, will be described. FIG. 14 is a diagram illustrating an example of the configuration of a gaming machine according to the present invention. The gaming machine is provided with game devices 40 and 41, and executes reel games 56 and 57 illustrated in FIG. 13, respectively. And extended device 42 attached to the gaming machine has a role to add a certain function to a symbol with reference to the symbol as described above, and a role to add a new game to the game, which the game device executes. In this configuration diagram, extended device 42 not only can add a game element to reel games 56 and 57, but also it can operate shared symbol 58 as well. For example, with reference to the reel game which game device executes, when a certain symbol appears, extended device can store the symbol in shared symbol 58. And when shared symbol 58 is filled with the symbols, the extended device is able to start a new game additionally.

The gaming machine is provided with system device 51. The system device is arranged to be able to operate game devices 40 and 41, extended device 42 and shared credit 53. Since the system device is set up so that an operator of a casino, etc. can operate, the operator can control game device and extended device independently, respectively. System device 51 can also further control Player tracking systems 49 and 50. Player tracking system is a system for performing tracking of the game play status of a player. Tracking system has roles for tracking the payouts 43 and 48, and credits 44 and 47 according to the progress of reel games 56 and 57, and transmit the information to the operator.

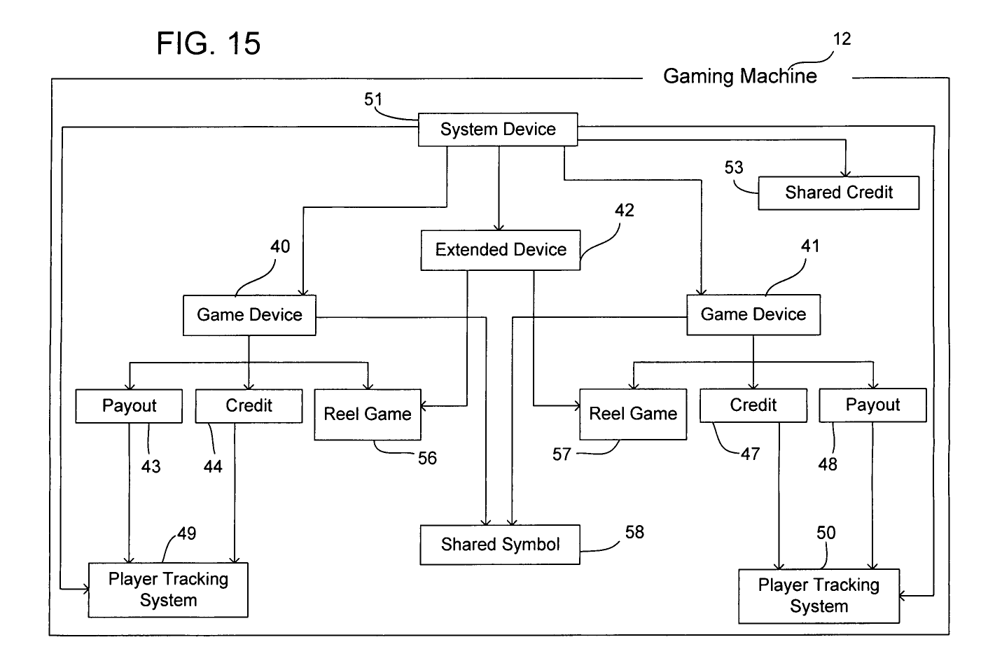

On the other hand, FIG. 15 is also a diagram illustrating an example of a configuration of the gaming machine according to the present invention. The different points between FIG. 14 and FIG. 15 are that the device for controlling the shared symbol is different. In FIG. 14, extended device 42 controls shared symbol 58. However, in FIG. 15, game devices 40 and 41 control shared symbol 58. In this game, such operation structure is also possible.

A game system for executing this game explained in FIGS. 14 and 15 is not limited above-described structure. It may be any kind of structure, as long as this game embodiment can be executed. For example, it may have three or more game devices into one gaming machine, and these game devices may execute three or more reel games. Shared credit 53, shared symbol 58, etc. do not need to exist. A plurality of extended devices may exist.

The gaming machine, which can be shared by two or more players may exist. For example, in the case where players must perform game operations within predetermined time, the time limit may be the same. The time limit of each player differs and time may be supplied from a certain player to other players. For example, in cases where the time limit of player A is 30 seconds and the time limit of player B is 30 seconds, player A may provide player B with 10 seconds, and the time limit of player B may be 40 seconds.

A pay line, which continues through a plurality of reels, (for example, both reels 56 and 57) may exist. That is, a pay line, which exists in reel 56, and a pay line which exists in reel 57 are connected, and when winning combination gathers on the connected pay line, a big prize may be paid back based on the hardness to be perfect. The pay line, which continues through two or more reels, does not always need to exist. For example, it may appear suddenly at the timing in the bonus game, and is usable at various timings.

Next, other embodiments of the present invention will be described in detail. In the present invention, an attribute or an element attached to a game symbol does not need to be a “gaming symbol” itself. For example, if a “RED-7” symbol displayed on the reel is a jackpot symbol of a game, an extended device refers the “attribute” of “jackpot symbol” of the RED-7 symbol, not the “RED-7” symbol itself. That is, after the extended device refers to “attribute” of the symbol used in a game, the extended device adds a function to the symbol, or plays a role, which adds a game element to the symbol.

By using the concept above, followings linked games and slot machine idea will be possible. The idea is linking games and slot machines on the same linked bonus games without changing the contents of the games and slot machines.

Existing this kind of linked bonuses or games are archived as “mystery jackpot” or “random jackpot” games, which bonuses are games and are initiated randomly, and game play results can't affect the bonus trigger condition. In the other words, only the same game type on gaming machines can be linked for a machine linked jackpots. Otherwise it has to be mystery jackpot before.

However, player's favor varies and there are a variety of games in casinos. Even though players go to casinos with family and friends, they may not like the same games. For example, someone likes a stepper slot machine game. The other person likes a video slot version of the game. There are people who like video poker games.

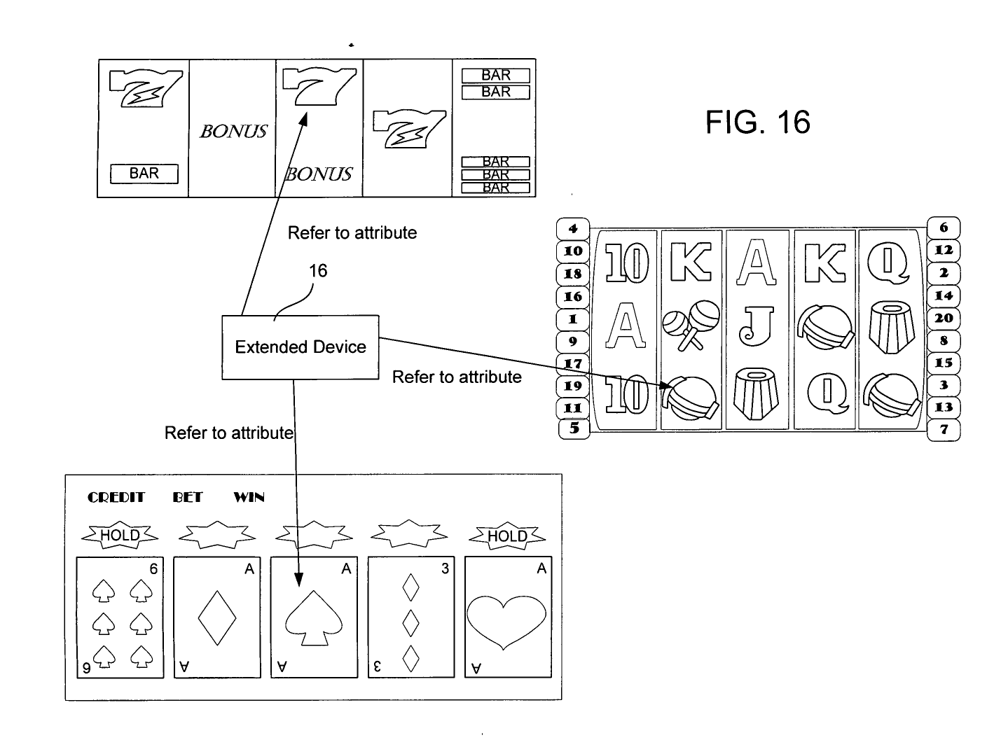

In the present invention, the extended device may be running for each game on slot machines independently and referring an attribute (Jackpot Symbol). In the 5 reel slot game, the attribute may be attached to a RED-7 symbol. In the video reel game, the attribute may be attached to a pearl symbol. In the video poker game, the attribute may be attached to a Spade-ACE card (refer to FIG. 16). The attribute may win a linked jackpot and may be shared among different games types.

In this idea, the extended device may be communicating with shared bonus system (e.g. a center bonus unit of the multi-station slot machine). Hereinafter, examples will be shown in case #1 and case #2.

(Case #1) In the case of which these three games are independent slot machines, a master extended device which is one of the extended device of the slot machines monitors the attribute for the shared bonus game.

(Case #2) In the case of a multi-station game, it allows multiple game types can be linked for the shared bonus game.

In both cases, bonus trigger condition or mechanism are still same and an extended device of a slot machine refers attributes attached to the game symbols, adding capability of linking a variety of game types link. If the extended device is controlled by a casino management system, it will be possibly to link player groups, or players who has relations (family, friends, etc. . . . ) for a shared bonus even if their favorite games is different.

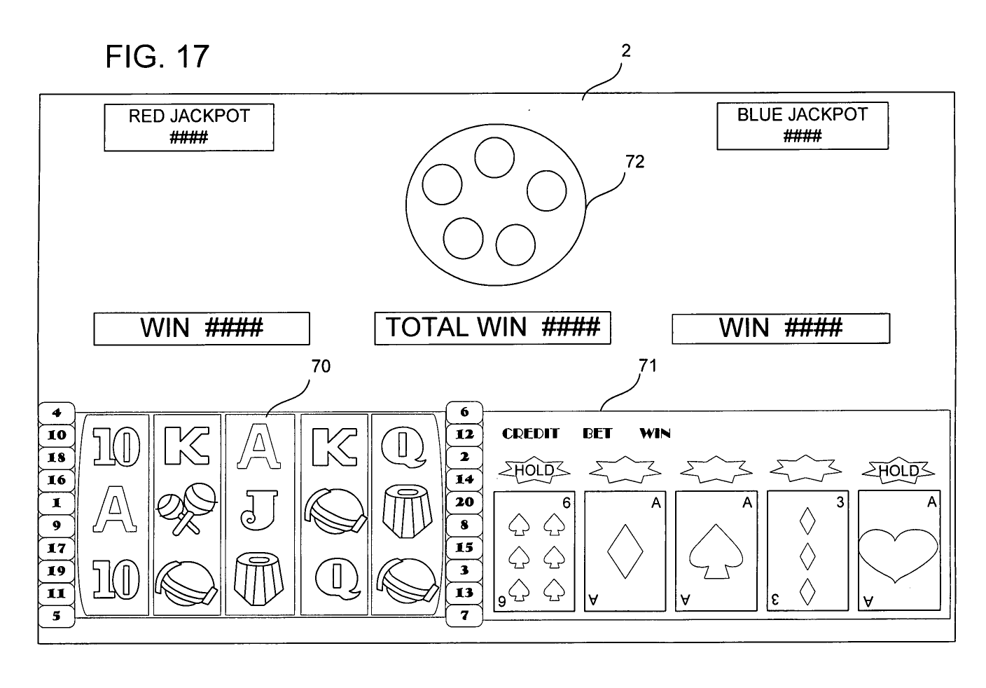

FIG. 17 illustrates an example in which one gaming machine executes games which are equal to or more than two types of games. Since a gaming machine is capable of executing different types of games as shown in FIG. 17, although it is a case where two or more players have intention to play different types of games, it is possible to simultaneously play games on one gaming machine without two or more players leaving distance with each other. FIG. 17 illustrates display 2. Video reel 70 and video poker 71 are shown in display 2. In an example of FIG. 17, two players can play video reel 70 and video poker 71, respectively.

Timing by which video reel 70 and video poker 71 are executed does not need to be the same. That is, for example, while video reel 70 is executed, video poker 71 does not need to be executed. On the other hand, video reel 70 and video poker 71 may be executed simultaneously. One cycle of video reel 70 (from the when a reel rotates to the time when the reel stops) and one game of video poker 71 (until the last hand of a player, which is originated in the card delivered to the player, is determined) do not need to be simultaneously executed. For example, while one game of video poker 71 is performed, video reel 70 may perform a plurality of cycles. On the other hand, video poker 71 may simultaneously perform the first game while video reel 70 performs the first cycle and both games may be designed to simultaneously start the second cycle or perform the second game simultaneously.

On the other hand, the number of games displayed on one display may not be limited to two, but may be any number. For example, in addition to the above-mentioned example, a blackjack game etc. may be executed and three or more types of games may be displayed on a display. Two or more games to be displayed on the display do not need to be performed on one display. For example, a slot machine has two or more displays, and two or more different types of games or the same types of games may be executed using these two or more displays. Further, the types of games executed on the display may be not only video reel and video porker, etc. but also may be a slot game for which a stepper is used, a keno game, a bingo game and a roulette game, etc. In this case, a slot game of a video reel and a stepper may be executed simultaneously. This is because although both are slot games, there are a player who likes a video reel and a player who likes a stepper reel. In the present invention, for example, the same type of game is defined as a game being like a slot game which uses a video reel or a stepper reel. On the other hand, in the present invention, the game of the different type of games are defined as games being divided into a game using a reel and a game using cards, just like a video reel and video porker, for example.

In the case where two or more different types of games are displayed as shown in FIG. 17, it is possible to set up a gaming machine so that a game rule which was described in the above-mentioned FIG. 13 may be adopted. For example, it is also possible to design the gaming machine so that mutual results may affect the contents of the games and a game result on the other side between games of two or more different types. It is also possible to display a combined result of two or more different types of games. For example, it is also possible to display a symbol obtained by a video reel, suit obtained on video poker, etc. on circle display 72.

In the present invention, in the case where one gaming machine performs two or more games, this gaming machine may have two or more operation units (not shown) which is capable of operating two or more games. For example, there are two games, which are controlled by a game device provided in the gaming machine, and this gaming machine may be provided with a first controller, which controls one game, and a second controller, which controls the other game. One game, which is executed by the game device being operated by the first controller, may exist, and the other game, which is executed by the extended device being operated by the second controller, may exist. The number of games, which are respectively executed by the game device and the extended device may not be limited to one, but may be any number. The number of the controllers does not need to be two but may be any number.

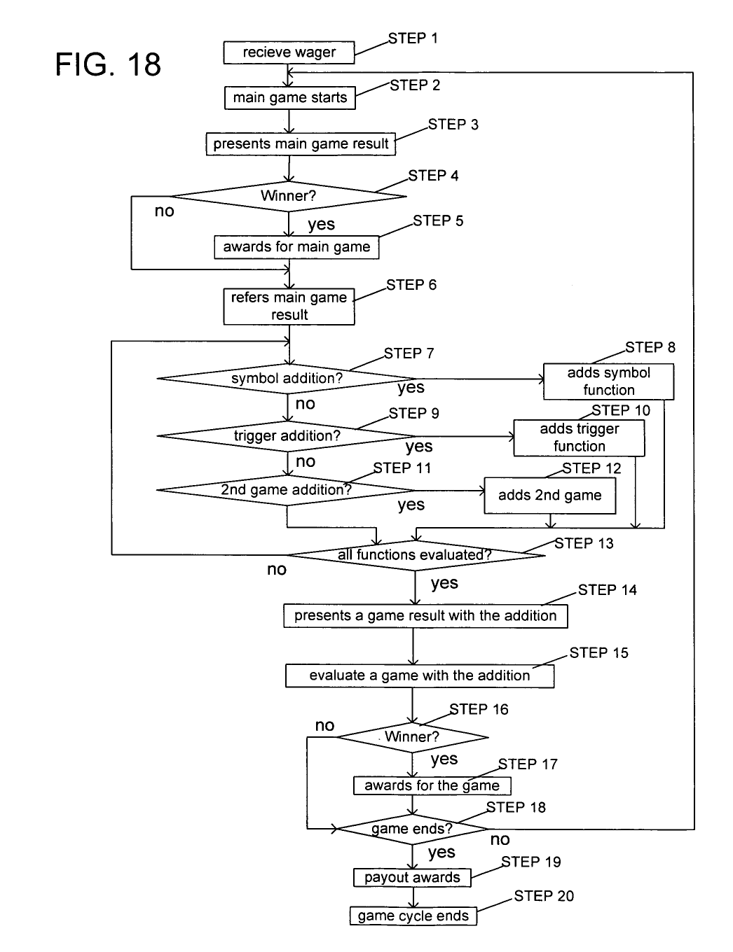

Next, operations performed by the gaming machine according to the present invention are described. FIG. 18 is an example of a flowchart of the operations performed by the gaming machine according to the present invention. In FIG. 18, after the gaming machine has first received a wager (Step 1), the game device starts a main game (Step 2). After the main game has been played, a result of the main game is presented (Step 3). Then, it is determined whether or not the result is winning (Step 4). When the main game result is winning, an award is determined (Step 5). On the other hand, if the main game result is not winning, and the award is determined, the extended device refers to the main game result (Step 6).

After the extended device has referred to the main game result, the extended device determines content of a function to be added to the game. Upon determination of the items to be added, it is first determined whether or not a new function is added to a symbol used in the game (Step 7), and when applicable, the new function is added to the symbol (Step 8). On the other hand, when not applicable, it is determined whether or not a trigger condition in the game is added (Step 9). When applicable, the trigger condition is added (Step 10). On the other hand, if not applicable, it is determined whether or not a secondary game is added (Step 11). When applicable, the secondary game is added (Step 12).

Finally, it is evaluated whether or not it has been determined whether or not all elements that can be added to the game are added (Step 13). When it has not been evaluated whether or not all the elements are added, it is evaluated whether or not they are again added (Steps 7, 9, and 11). When it is determined that all the elements have been evaluated, a game result including the additional items is presented (Step 14). Subsequently, content of the game including the additional items is evaluated (Step 15), and it is determined whether or not the game content is winning (Step 16). When the game content is winning, an award is paid out (Step 17). On the other hand, when the game content is not winning, and the award is paid out, it is determined whether or not the entire game is ended (Step 18).

When it is determined that the entire game is not ended, the main game is again started (Step 2). When it is determined that the entire game is ended, payout is made to a player (Step 19), and then the game cycle is ended (Step 20). Note that elements to be added to a symbol, other than the function (Step 7), trigger condition (Step 9), and secondary game, include those as described above, and the additional elements are not limited to the three items. Also, it is not indispensable to evaluate the three elements, but only one or two of them may be evaluated.

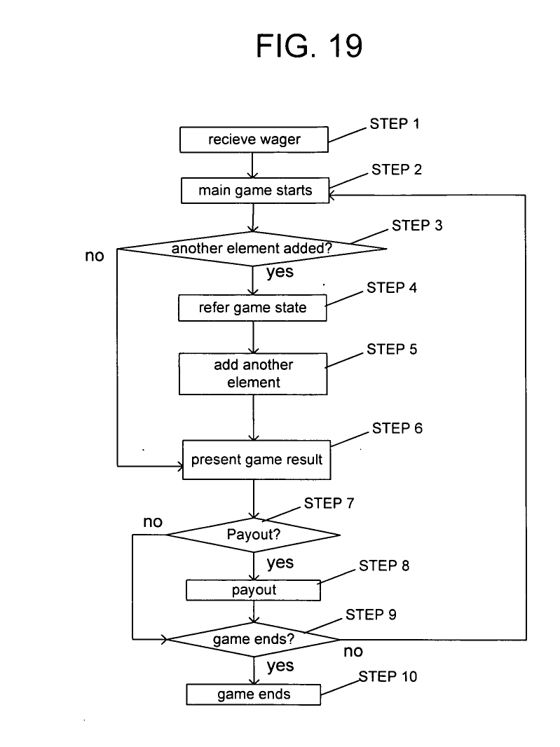

FIG. 19 is an example of a flowchart of operations performed by the gaming machine according to the present invention. In FIG. 19, after the gaming machine has first received a wager (Step 1), the game device starts a main game (Step 2). After the main game has been started, it is determined whether or not the extended device adds the other element to the main game (Step 3). When the other element is added, the extended device refers to content of the main game (Step 4), and then adds the other element to the main game (Step 5). In either case of adding or not adding the other element, a result of the main game is presented (Step 6).

After the main game result has been presented, it is determined whether or not payout is made on the basis of the result (Step 7). When it is determined that the payout is made, the payout is made to a player (Step 8). After the payout has been or has not been made, it is determined whether or not the entire game is ended (Step 9). When it is determined that the entire game is not ended, the main game is again started (Step 2). When it is determined that the entire game is ended, the game cycle is ended (Step 10).

As above, the gaming machine according to the present invention has been described; however, it goes without saying that the present invention is not limited to the above, but as far as an embodiment has an essential part of the present invention, the embodiment falls within the scope of rights of the present invention even if it is embodied in any configuration.

What is claimed is:

1. A gaming machine for providing a display and paying out award, comprising:
a storage device, which stores a game data to implement at least two games of the same type;
an extended device, which adds a game element to the two games; and
a game device, which implements the two games of the same type,
wherein the extended device works independently of the game device.

2. A gaming machine of claim 1, wherein the two games of the same type have a plurality of symbols with a function, and the extended device adds other function to any one of the symbols.

3. A gaming machine of claim 1, wherein the game device implements the two games of the same type on the display.

4. A gaming machine of claim 1, wherein the two games of the same type are a reel game or a card game.

5. A gaming machine of claim 1, wherein the extended device adds the game element to one game of the two games depending on the other game result of at least the two games.

6. A gaming machine of claim 2, wherein the extended device adds the other function to the symbol of one game of the two games depending on the other game result of at least the two games.

7. A gaming machine of claim 1, wherein the game device combines one game result with the other game result in the two games, and displays a combined game result on the display.

8. A gaming machine of claim 1, wherein the game device combines a game score of one game with a game score of the other game in the two games, and displays a combined game score on the display.

9. A gaming machine of claim 1, wherein the game device combines credit of one game with credit of the other game in the two games, and displays combined credit on the display.

10. A gaming machine of claim 1, wherein the game device combines an item or a symbol of one game with an item or a symbol of the other game in the two games, and displays combined items or symbols on the display.

11. A gaming machine of claim 1, wherein the gaming machine includes a plurality of displays, and the game device displays the two games on the plurality of displays.

12. A gaming system for providing game play and paying out award, comprising:
a storage unit, which stores a program for implementing at least two games of the same type and other program for implementing a game independently of the two games;
an executor, which executes the program for implementing the two games of the same type after receiving information for operating the executor;
a controller, which implements the other program independently of the execution of the program for implementing the two games of the same after receiving information for operating the controller; and
a managing unit, which transmits the information for operating the executor and transmits the information for operating the controller;
wherein the executor works independently of the controller.

13. A gaming system of claim 12, wherein the controller implements the other program to pay out additional award when the award is pay out according to the game play.

14. A gaming system of claim 13, wherein total of the award and additional award is a multiples of the award.

15. A gaming system of claim 12, wherein the controller implements the other program to provide a coupon or a complimentary ticket.

16. A gaming system of claim 12, wherein the managing unit synchronizes play cycle between the executor and the controller.

17. A gaming machine, which is capable of receiving a bet and paying out a reward, comprising:
a game device, which is capable of executing at least two games;
a controller, which operates one game of the two games; and
another controller, which operates the other game of the two games,

18. A gaming machine of claim 17, wherein the gaming machine is linked to at least the other gaming machine.

19. A gaming machine of claim 17, further comprising:
an extended device,
wherein the game device executes a game operated by the controller, the extended device executes a game operated by the another controller and the game device works independently of the extended device.

20. A gaming machine of claim 17, wherein a type of the one game is different from a type of the other game.

21. A gaming machine of claim 17, wherein a type of the one game is the same as a type of the other game.

22. A gaming machine of claim 17, wherein the game device is capable of executing at least two games at substantially the same timing.

23. A gaming machine of claim 19, wherein the game device synchronizes with the extended device on play cycle.

24. A gaming machine of claim 17, further comprising:
an extended device,
wherein the extended device applies an additional element to the one game.
